(19) United States
(12) Patent Application Publication
(10) Pub. No.: US 2008/0056764 A1
(43) Pub. Date: Mar. 6, 2008

(54) Driving assembly of photoconductive drum

(76) Inventor: Chin-Hung Chung, Taoyuan Hsien (TW)

Correspondence Address: CHIN-HUNG CHUNG, 235 Chung - Ho, Box 8-24, Taipei, omitted

(21) Appl. No.: 11/803,371

(22) Filed: May 15, 2007

(30) Foreign Application Priority Data
Sep. 6, 2006 (TW) 095215803

(51) Int. Cl. G03G 15/00

(52) U.S. Cl. 399/167

(57) ABSTRACT

A driving assembly of a photoconductive drum comprises a driving gear having a body; a post passing through a center of the body; an end surface of the post being formed with a triangular recess; the triangular recess having a helical inner surface; a driven gear including a body; an end surface of the body of the driven gear having an engaging block corresponding to the triangular recess; the engaging block having a rounded tip portion corresponding to the triangular recess of the driving gear; each of two sides of the rounded tip portion being formed with a respective reduced portion so that the engaging block is formed with a pentagonal cross section. Furthermore in another design, the engaging block may have two rounded tip portions, and only one reduced portion is formed so that the cross section of the engaging block is formed as a trapezoidal shape.

### FIELD OF THE INVENTION

The present invention relates to laser printers, and particularly to a driving assembly of a photoconductive drum, wherein an engaging block of the driven gear has at least one reduced portion so that the engagement between the triangular recess and engaging block is preferable than the prior art.

### BACKGROUND OF THE INVENTION

With the progress of technology, laser printers have widely used in printing computer data. The photoconductive drum is installed to a laser printer, as shown in FIG. 1, The drum includes a driving gear 1 having a body 11. A post 12 passes through a center of the body 11. An end surface of the post 12 is formed with a triangular recess 13. The triangular recess 13 has a helical inner surface.

A driven gear 2 includes a body 21. An end surface of the body 21 of the driven gear 2 has an engaging block 22 corresponding to the triangular recess 13. The engaging block 22 has three rounded tip portions 221 (referring to FIG. 1) corresponding to the triangular recess 13 of the driving gear 1 so as to form a triangular cross section. The connecting surface between two rounded tip portions 221 is formed as an inclined surface 222. The three rounded tip portions 321 are engaged to the three corners of the triangular recess 13 of the driving gear 1. However, the round tip portions have no function in the engagement with the triangular recess 13 of the driving gear 1. Only the inclined surfaces 222 are used to be engaged to the triangular recess 13.

### SUMMARY OF THE INVENTION

Accordingly, the primary object of the present invention is to provide a driving assembly of a photoconductive drum, wherein the engaging block of the driven gear has at least one reduced portion so that the engagement between the triangular recess and engaging block is preferable than the prior art.

To achieve above objects, the present invention provides a driving assembly of a photoconductive drum comprising: a driving gear having a body; a post passing through a center of the body; an end surface of the post being formed with a triangular recess; the triangular recess having a helical inner surface; a driven gear including a body; an end surface of the body of the driven gear having an engaging block corresponding to the triangular recess; the engaging block having a rounded tip portion corresponding to the triangular recess of the driving gear; each of two sides of the rounded tip portion being formed with a respective reduced portion so that the engaging block is formed with a pentagonal cross section so that the rounded tip portion can be engaged to the triangular recess of the driving gear. Furthermore in another design, the engaging block may have two rounded tip portions, and only reduced portion is formed so that the cross section of the engaging block is formed as a trapezoidal shape.

The various objects and advantages of the present invention will be more readily understood from the following detailed description when read in conjunction with the appended drawing.

### BRIEF DESCRIPTION OF THE DRAWINGS

FIG. 1 is a structural schematic view of the prior art.

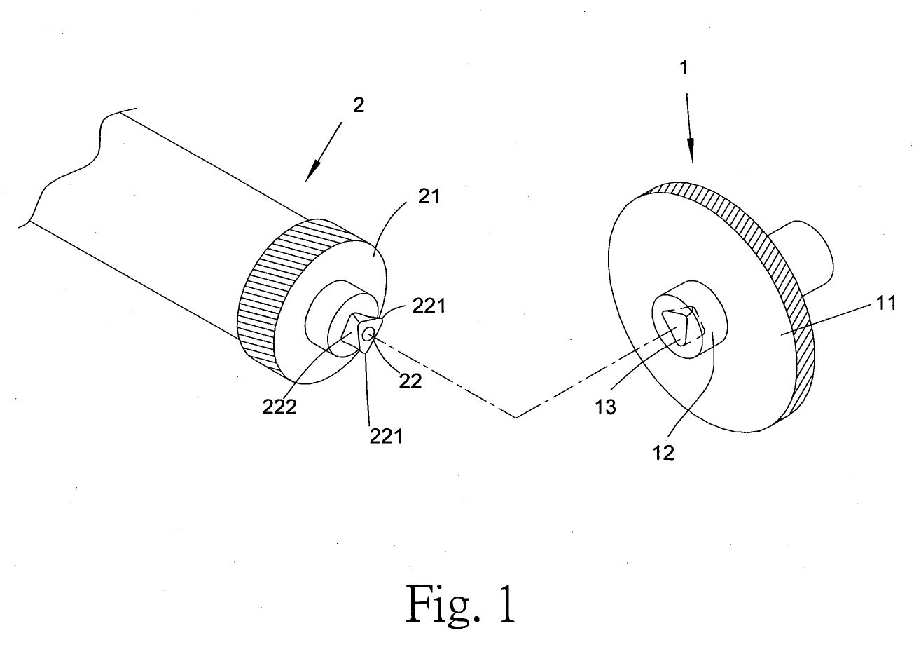

FIG. 2 is a structural schematic view of the present invention.

FIG. 3 is a plane view showing the engaging block of the present invention.

FIG. 4 is a schematic view about the engaging block of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

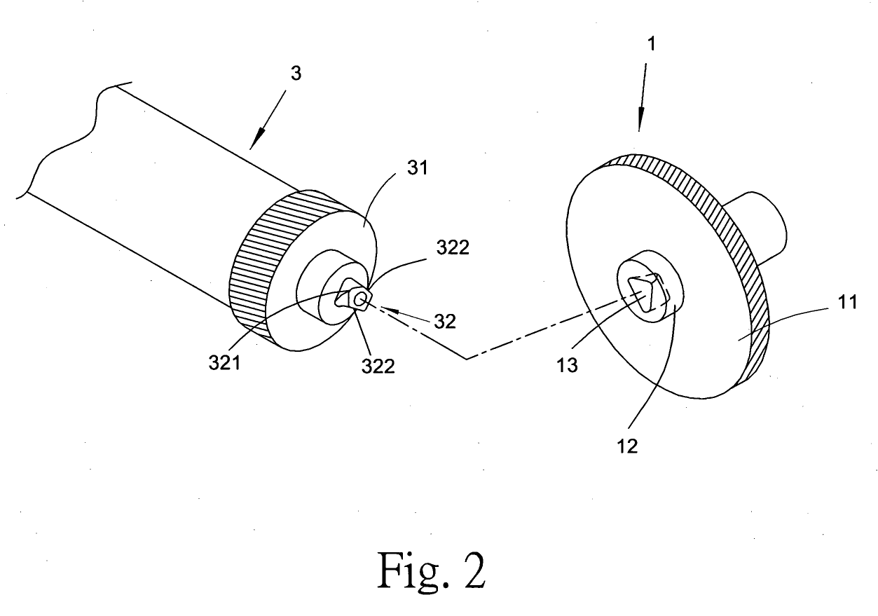

Referring to FIGS. 2, 3 and 4, the driving assembly of a light sensing drum of a laser printer according to the present invention is illustrated. The present invention has the following elements.

A driving gear 1 has a body 11. A post 12 passes through a center of the body 11. An end surface of the post 12 is formed with a triangular recess 13. The triangular recess 13 has a helical inner surface.

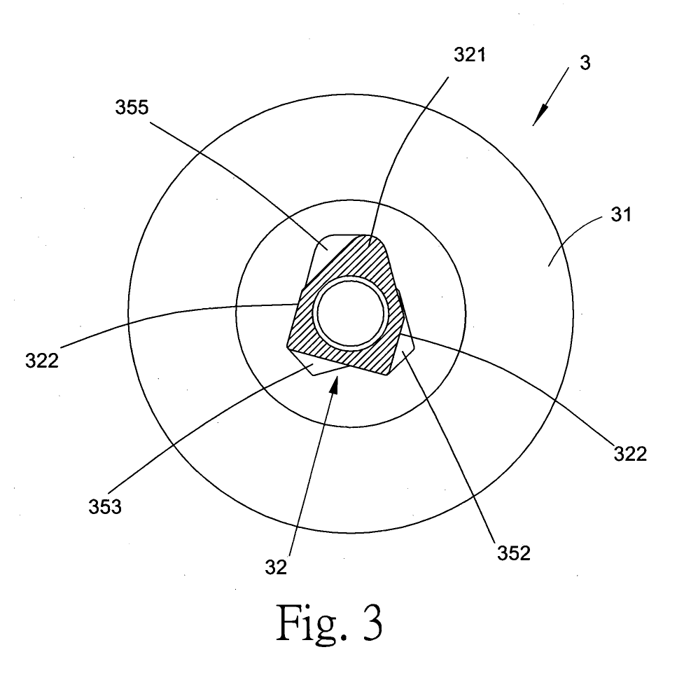

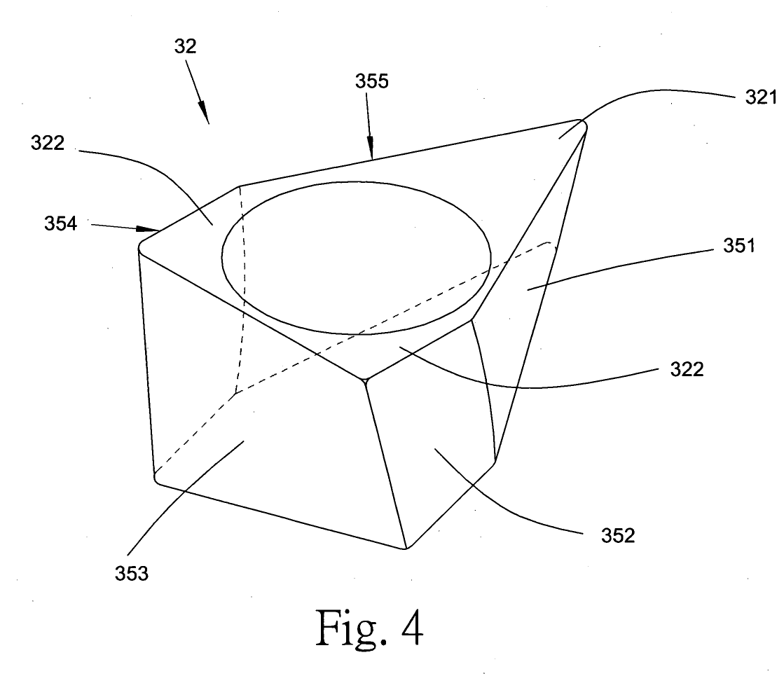

A driven gear 3 includes a body 31. An end surface of the body 31 of the driven gear 3 has an engaging block 32 corresponding to the triangular recess 13. The engaging block 32 has a rounded tip portion 321 (referring to FIG. 3) corresponding to the triangular recess 13 of the driving gear 1. Each of two sides of the rounded tip portion 321 is formed with a respective reduced portion 322 so as to form a pentagonal cross section (referring to FIG. 3) so that the rounded tip portion 321 can be easily engaged to the triangular recess 13 of the driving gear 1. The reduced portions 322 serve to reduce the friction between the rounded tip portion 321 and the triangular recess 13, but they did not affect the engagement between the rounded tip portion 321 and the triangular recess 13. With reference to FIG. 4, by above mentioned structure, a periphery of the engaging block 32 is formed with a first cutting surface 351, a second cutting surface 352, a third cutting surface 353, a fourth cutting surface 354 and a five cutting surface 355. Each cutting surface can be well engaged with an inner wall of the triangular recess 13.

Furthermore in the present invention, the engaging block 32 may have two rounded tip portions 321, and only reduced portion 322 is formed (not shown) so that the cross section of the engaging block 32 is formed as a trapezoidal shape. This structure has the same effect as above mentioned structure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A driving assembly of a photoconductive drum comprising:
a driving gear having a body; a post passing through a center of the body; an end surface of the post being formed with a triangular recess; the triangular recess having a helical inner surface;
a driven gear including a body; an end surface of the body of the driven gear having an engaging block corresponding to the triangular recess; the engaging block having a rounded tip portion corresponding to the triangular recess of the driving gear; each of two sides of the rounded tip portion being formed with a respective reduced portion so that the engaging block is formed with a pentagonal cross section so that the rounded tip portion can be engaged to the triangular recess of the driving gear.

2. The driving assembly of a photoconductive drum as claimed in claim 1, wherein a periphery of the engaging block is formed with a first cutting surface, a second cutting surface, a third cutting surface, a fourth cutting surface and a five cutting surface.

3. A driving assembly of a photoconductive drum comprising:
a driving gear having a body; a post passing through a center of the body; an end surface of the post being formed with a triangular recess; the triangular recess having a helical inner surface;
a driven gear including a body; an end surface of the body of the driven gear having an engaging block corresponding to the triangular recess; the engaging block having two rounded tip portions, and only one reduced portion being formed so that the cross section of the engaging block is formed as a trapezoidal shape.
